(19) United States
(12) Patent Application Publication
(10) Pub. No.: US 2007/0160398 A1
(43) Pub. Date: Jul. 12, 2007

(54) Fixing unit for electrophotographic image forming apparatus

(75) Inventor: Ho-min Lim, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/639,294

(22) Filed: Dec. 15, 2006

(30) Foreign Application Priority Data
Jan. 6, 2006 (KR) 2006-1680

(51) Int. Cl. G03G 15/20

(52) U.S. Cl. 399/328

(57) ABSTRACT

A fixing unit for fixing a toner image on a paper sheet is provided with a heat roller which heats a paper sheet on which a toner image is transferred; a pressure roller which forms a contact nip with the heat roller and presses the paper sheet passing through the contact nip while the pressure roller and the heat roller rotate in conjunction with each other; and a contact nip adjusting element which changes the contact nip by shifting the pressure roller in a paper feed direction. As a result, the contact nip between the heat roller and the pressure roller is actively adjusted using the contact nip adjusting element to control paper skewing. Therefore, a toner image is not blurred when the toner image is touched by adjacent units prior to a fixing operation.

### CROSS-REFERENCE TO RELATED APPLICATIONS

This application claims all benefits accruing under 35 U.S.C §119 from Korean Application No. 2006-1680, filed Jan. 6, 2006, in the Korean Intellectual Property Office, the disclosure of which is incorporated by reference herein.

### BACKGROUND OF THE INVENTION

1. Field of the Invention

The present invention relates to a fixing unit for an electro-photographic image forming apparatus, which fixes an image on a printable medium, such as a paper sheet, using heat and pressure.

2. Related Art

Generally, electro-photographic image forming apparatuses, such as laser beam printers, photocopiers, facsimile machines and multi-functional products, are devices for printing an image on a printable medium, such as a paper, by an electro-photographic process. In such an image forming apparatus, an electrostatic latent image is formed on a photosensitive body, such as a photosensitive drum, and developed into a toner image. Specifically, a toner image is developed onto a paper sheet by a developing unit, and is then fixed on the paper sheet using heat and pressure by a fixing unit. By fixing the toner image on the paper sheet after the toner image is developed onto the paper sheet, the toner image is not blurred when a user rubs the toner image on the paper sheet.

FIG. 1 is a schematic view of a part of a conventional fixing unit for an image forming apparatus. Referring to FIG. 1, a fixing unit includes a metal heat roller 10 having a heater (not shown) and a rubber pressure roller 20. A developing unit 31 is also shown to develop an electrostatic latent image into a toner image. Typically, such a developing unit 31 includes a developer roller and toner (not shown), and is removably mounted into a main body of the image forming apparatus. A photosensitive drum 30 is either mounted in the developing unit 31 or fixed to the main body of the image forming apparatus, according to the type of the image forming apparatus utilized. A transfer roller 40 is arranged to face the photosensitive drum 30, and to transfer the toner image from the photosensitive drum 30 to each paper sheet 1 upon an application of a bias voltage.

At the fixing unit, the heat roller 10 and the pressure roller 20 rotate, with being tightly in contact with each other by high pressure. Since the pressure roller 20 is relatively soft, a contact nip N is formed in a shape in which the contact nip N is pressed toward the pressure roller 20. As a result, when a printable medium, such as a paper sheet 1 with a toner image passes through the contact nip N prior to passing between the photosensitive drum 30 and a transfer roller 40, the front end and rear end of the paper sheet 1 become slightly skewed upwards, as shown in FIG. 1.

However, the problem is that the toner image transferred by the photosensitive drum 30 may be easily blurred when the rear end of the skewed paper sheet 1 contacts adjacent units such as the developing unit 31. For the front end of the paper sheet 1, the toner image is fixed on the paper sheet 1 prior to passing through the contact nip N. As a result, the toner image is not blurred, even when the front end of the paper sheet 1 is swept by the adjacent units, such as the developing unit 31. However, in this case, since the rear end of the paper sheet 1 does not pass through the contact nip N yet, the toner image may be blurred when the rear end of the paper sheet 1 is swept by the adjacent units.

To solve this problem, a method has been suggested to reduce a contact force between the pressure roller 20 and the heat roller 10 so as to make the paper sheet 1 be less skewed at the contact nip N. In this method, if an image on the rear end of the paper sheet 1 is frequently blurred, the contact force between the heat roller 10 and the pressure roller 20 is reduced to decrease the skew of the paper sheet 1, so that the toner image on the rear end of the paper sheet 1 is not blurred when the rear end of the paper sheet 1 contacts the adjacent units. This is an effective method when a thin paper sheet is used as a printable medium. However, for a thick paper sheet, such as a cardboard, the method that slightly reduces the contact force makes no difference. In fact, when the thick paper sheet passes through the contact nip N, the front end and the rear end of the paper sheet 1 are more skewed. Thus, the front end and the rear end of the paper sheet 1 are highly likely to contact the adjacent units, even though the contact force is reduced.

Recently, an envelope is widely used as a printable medium. However, such an envelope has an air layer formed inside thereof. As a result, when the envelope reaches to the contact nip N, with the rear end of the envelope being skewed, as shown in FIG. 1, the upper surface and the lower surface of the envelope are apart from each other due to the air layer formed therebetween, thereby causing crumpling.

### SUMMARY OF THE INVENTION

Several aspects and example embodiments of the present invention provide a fixing unit for an image forming apparatus, in which a rear end of a printable medium is less skewed, even when a thick paper sheet or an envelope is used as the printable medium, thereby preventing printing errors.

Additional aspects and/or advantages of the invention will be set forth in part in the description which follows and, in part, will be obvious from the description, or may be learned by practice of the invention.

In accordance with an embodiment of the present invention, a fixing unit for an image forming apparatus, is provided with: a heat roller which heats a paper sheet on which a toner image is transferred; a pressure roller which forms a contact nip with the heat roller and presses the paper sheet passing through the contact nip while the pressure roller and the heat roller rotate in conjunction with each other; and a contact nip adjusting element which changes the contact nip by shifting the pressure roller in a paper feed direction.

According to an aspect of the present invention, the contact nip adjusting element may comprise: a bush which supports a rotation axis of the pressure roller and has a guide slit on a body frame of the bush; a guide rail which guides lifting or lowering of the bush, and has a contact rib so that the bush is projected through the guide slit when the bush is lowered; an elastic member which provides an elastic force to the bush in a direction that the pressure roller tightly comes in contact with the heat roller; and a control lever which moves the pressure roller to the opposite direction with respect to an electric force of the elastic member, wherein, when the pressure roller is moved in the opposite direction with respect to the elastic force of the elastic member by the control lever, the bush is lowered, the contact rib is projected through the guide slit, and the projected contact rib comes in contact with the rotation axis of the pressure roller, thereby shifting the rotation axis.

According to another aspect of the present invention, the rotation axis may be shifted in a manner in which the shift of the rotation axis is composed of a first shift component in the paper out-feed direction and a second shift component in a direction that the pressure roller is separated from the heat roller. In addition, the second shift component may be performed until the pressure roller is completely separated from the pressure roller.

According to an aspect of the present invention, the control lever may comprise: a first hinge lever having a long hole connected to the rotation axis of the pressure roller; and a second hinge lever moving in conjunction with the first hinge lever, wherein, when the second hinge lever rotates, the first hinge lever rotates in conjunction with the second hinge lever and shifts the rotation axis of the pressure roller, where the rotation axis is joined with the long hole. In addition, the bush may have an asymmetric structure.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a schematic view of a part of a conventional fixing unit for an image forming apparatus;

FIG. 2 illustrates an example fixing unit according to an embodiment of the present invention; and

FIGS. 3 and 4 illustrate a shift operation of a pressure roller included in the fixing unit shown in FIG. 2.

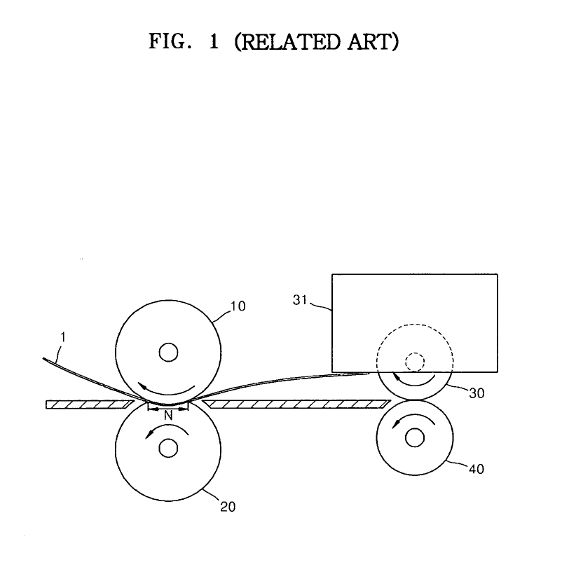

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

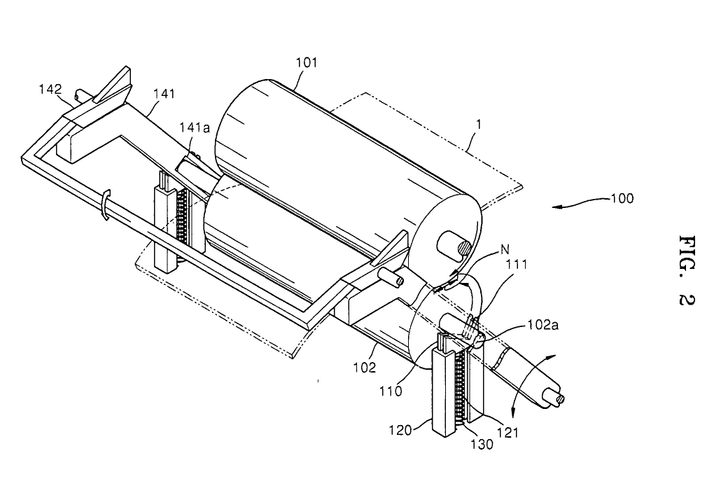

FIG. 2 illustrates a fixing unit 100 according to an embodiment of the present invention.

Referring to FIG. 2, the fixing unit 100 includes a metal heat roller 101 having a heater (not shown) and a rubber pressure roller 102 for pressing a printable medium such as a paper sheet 1. The two rollers, the heat roller 101 and the pressure roller 102 rotate in conjunction with each other, and a contact nip N is formed between the two rollers 101 and 102. When the paper sheet 1 passes through the contact nip N after a toner image is transferred onto the paper sheet 1, the heat roller 101 applies a high temperature thereto, and the pressure roller 102 applies a high pressure thereto. Thus, the toner image is fixed on the paper sheet 1 by the heat and pressure.

The fixing unit 100 may further include a contact nip adjusting mechanism. The contact nip adjusting mechanism controls the contact nip N by adjusting the position of the pressure roller 102. The extent of skewing of the rear end of the paper sheet 1 when the paper sheet 1 enters into the contact nip N can be adjusted by the contact nip adjusting element. The contact nip adjusting mechanism includes a bush 110 which supports a rotation axis 102a of the pressure roller 102, a guide rail 120 which guides the lifting or lowering of the bush 110, a spring 130 which applies an elastic force to the bush 100 in a direction the pressure roller 102 comes in contact with the heat roller 101, a first hinge lever 141 having a long hole (opening) 141a to be inserted into the rotation axis 102a of the pressure roller 102, and a second hinge lever 142 which moves in conjunction with the first hinge lever 141.

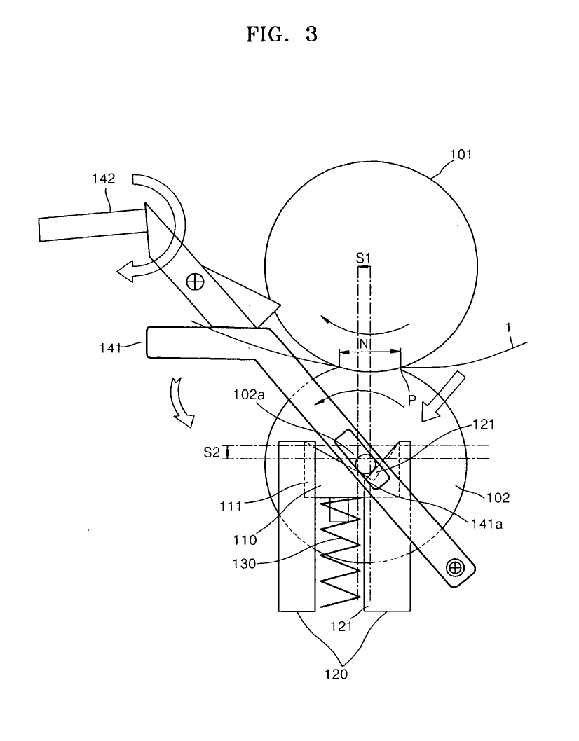

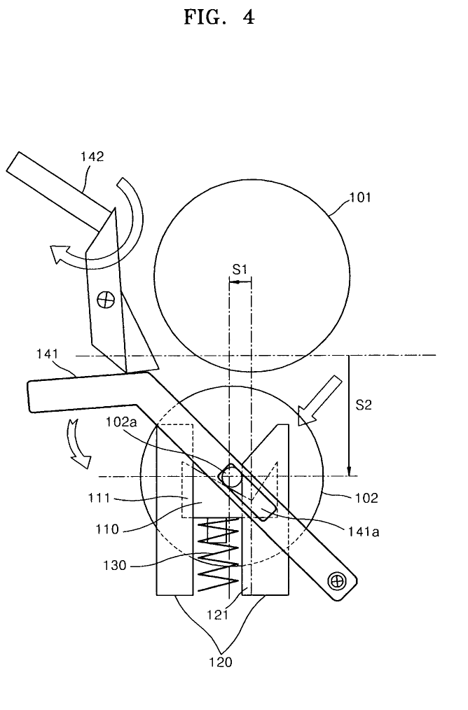

Referring to FIGS. 3 and 4, a shift operation of a pressure roller included in the fixing unit using the contact nip adjusting mechanism according to an embodiment of the present invention is illustrated. As shown in FIG. 3, when a user rotates the second hinge lever 142, the first hinge lever 141 also rotates, and thus the rotation axis 102a of the pressure roller 102 is lowered against the elastic force of the spring 130. Here, the rotation axis 102a of the pressure roller 102 is joined in the long hole (opening) 141a of the first hinge lever 141. The bush 110 has a guide slit 111 which is inserted into the guide rail 120 in a sliding manner. The guide rail 120 has a contact rib 121 so that the contact rib 121 is projected through the guide slit 111, when the bush 110 is lowered.

As shown in FIG. 3, when the bush 110 is lowered, the contact rib 121 is projected and lifted to contact the rotation axis 102a of the pressure roller 102, and then shifts the rotation axis 102a along its tilt in a paper out-feed direction. Since the rotation axis 102 is shifted while the pressure roller 102 is lowered, the shift of the rotation axis 102 is composed of a first shift component S1 in the paper out-feed direction and a second shift component S2 in a direction that the pressure roller 102 is separated from the heat roller 101. In other words, the heat roller 101 and the pressure roller 102 are slightly separated from each other, that is, the contact force between the heat roller 101 and the pressure roller 102 is reduced, and at the same time, the rotation axis 102a of the pressure roller 102 is slightly shifted in the paper out-feed direction. As a result, a contact nip N area is slightly narrowed since the contact force is reduced by as much as the second shift component S2. Also, the contact nip N moves in the paper out-feed direction since the rotation axis 102a moves in the paper out-feed direction by as much as the first shift component S1.

When the paper sheet 1 enters into the changed contact nip N, the front end of the paper sheet 1 is more skewed upwards than before the change, but the rear end of the paper sheet 1 is less skewed upwards, as shown in FIG. 3. This is because a starting point P, at which the paper sheet 1 starts to be fed into the contact nip N formed between the heat roller 101 and the pressure roller 102, moves in the direction of the paper out-feed direction. As a result, the paper sheet 1 is skewed at a much later time, causing a change as shown in FIG. 3. In this case, after passing through the contact nip N, the front end of the paper sheet 1 is more likely to contact the adjacent units. However, since the toner image is fixed on the paper sheet 1 when the front end of the paper sheet 1 passes through the contact nip N, the image is not affected even when the front end of the paper sheet 1 is touched and swept by the adjacent units.

On the other hand, the rear end of the paper sheet 1 does not pass through the contact nip N yet, but the rear end of the paper sheet 1 is less skewed upwards due to the aforementioned shift. As a result, the rear end of the paper sheet 1 is less likely to be touched by the adjacent units. Therefore, the toner image is much less likely to be blurred. In this manner, the contact nip N is adjusted to actively prevent image blurring.

In general, when a thick printable medium (i.e., a cardboard) or an envelope is used as the paper sheet 1, the paper sheet 1 is significantly skewed and thus image blurring occurs. Therefore, before a fixing operation is performed, when a common paper sheet is used, the pressure roller 102 is required not to be shifted, as shown in FIG. 2. However, when a thick paper sheet 1 is used, the pressure roller 102 is required to be shifted as shown in FIG. 3.

When the paper sheet 1 is jammed or when maintenance is required, the first and second hinge levers 141 and 142 are further rotated, as shown in FIG. 4, to separate the pressure roller 102 from the heat roller 101. If the first and second hinge levers 141 and 142 are reversely rotated, the bush 110 is lifted by a restoring force of the spring 130, and thus the two rollers 101 and 102 come in contact with each other. To facilitate the fixing operation, the contact nip N between the two rollers 101 and 102 is changed, and when paper jam occurs, the two rollers 101 and 102 are separated with each other.

In this embodiment of the present invention, the second hinge lever 142 is manually operated. However, the second hinge lever 142 may be connected to a power driving source, such as a motor, so that the second hinge lever 142 can move in response to a control signal.

Accordingly, in a fixing unit of the present invention, a contact nip between a heat roller and a pressure roller is actively adjusted to control paper skewing. Therefore, a toner image is not blurred when the toner image is touched by adjacent units prior to a fixing operation.

While the present invention has been particularly shown and described with reference to exemplary embodiments thereof, it will be understood by those of ordinary skill in the art that various changes in form and details may be made therein without departing from the spirit and scope of the present invention. For example, components of a fixing unit as shown in FIGS. 2-4 can be arranged differently as long as the contact nip N formed between a heat roller and a pressure roller is controlled and adjusted in the manner described. Moreover, while the contact nip adjusting mechanism as described in connection with FIGS. 2-4 is utilized to adjust the position of the pressure roller, the same can also be made with respect to the heat roller, as long as the contact nip N is controlled and adjusted. Accordingly, it is intended, therefore, that the present invention not be limited to the various example embodiments disclosed, but that the present invention includes all embodiments falling within the scope of the appended claims.

What is claimed is:

1. A fixing unit for an image forming apparatus, comprising:
a heat roller which heats a paper sheet on which a toner image is transferred thereon;
a pressure roller which forms a contact nip with the heat roller and presses the paper sheet passing through the contact nip, while the pressure roller and the heat roller rotate in conjunction with each other; and
a contact nip adjusting mechanism which adjusts the contact nip by shifting the pressure roller in a paper feed direction.

2. The fixing unit as claimed in claim 1, wherein the contact nip adjusting mechanism comprises:
a bush which supports a rotation axis of the pressure roller and has a guide slit on a body frame of the bush;
a guide rail which guides lifting or lowering of the bush, and has a contact rib which is projected through the guide slit when the bush is lowered;
an elastic member which provides an elastic force to the bush in a direction that the pressure roller tightly comes in contact with the heat roller; and
a control lever which moves the pressure roller to the opposite direction with respect to an electric force of the elastic member,
wherein, when the pressure roller is moved in the opposite direction with respect to the elastic force of the elastic member by the control lever, the bush is lowered, the contact rib is projected through the guide slit, and the projected contact rib comes in contact with the rotation axis of the pressure roller, thereby shifting the rotation axis.

3. The fixing unit as claimed in claim 2, wherein the rotation axis is shifted in a manner in which the shift of the rotation axis is composed of a first shift component in the paper feed direction and a second shift component in a direction that the pressure roller is separated from the heat roller.

4. The fixing unit as claimed in claim 3, wherein the second shift component is performed until the pressure roller is completely separated from the pressure roller.

5. The fixing unit as claimed in claim 2, wherein the control lever comprises:
a first hinge lever having a long hole connected to the rotation axis of the pressure roller; and
a second hinge lever moving in conjunction with the first hinge lever,
wherein, when the second hinge lever rotates, the first hinge lever rotates in conjunction with the second hinge lever and shifts the rotation axis of the pressure roller, where the rotation axis is joined with the long hole.

6. The fixing unit as claimed in claim 2, wherein the bush has an asymmetric structure.

7. A fixing unit for an image forming apparatus, comprising:
a heat roller to heat a paper sheet on which a toner image is formed;
a pressure roller arranged in parallel with the heat roller to face the heat roller and to form a contact nip in an axial direction with the heat roller when the pressure roller is in contact with the heat roller, and to press the paper sheet as the paper sheet passes through the contact nip, while the pressure roller and the heat roller rotate in conjunction with each other; and
a contact nip adjusting mechanism arranged at both ends of the pressure roller, to adjust the contact nip in the axial direction by shifting the pressure roller in a paper feed direction so as to control paper skewing.

8. The fixing unit as claimed in claim 7, wherein the contact nip adjusting mechanism comprises:
a bush arranged at both ends of the pressure roller and to support a rotation axis of the pressure roller, and provided with a guide slit;
a guide rail arranged at both ends of the pressure roller to guide the lifting or lowering of the bush, and provided with a contact rib projected through the guide slit when the bush is lowered;
an elastic member to provide an elastic force to the bush in a direction that the pressure roller comes in contact with the heat roller; and
a control lever arranged to move the pressure roller to the opposite direction with respect to an electric force of the elastic member,
wherein, when the pressure roller is moved in an opposite direction with respect to the elastic force of the elastic member by the control lever, the bush is lowered, the contact rib is projected through the guide slit, and the projected contact rib comes in contact with the rotation axis of the pressure roller, thereby shifting the rotation axis.

9. The fixing unit as claimed in claim 8, wherein the rotation axis is shifted in a manner in which the shift of the rotation axis is composed of a first shift component in the paper feed direction and a second shift component in a direction that the pressure roller is separated from the heat roller.

10. The fixing unit as claimed in claim 8, wherein the second shift component is performed until the pressure roller is completely separated from the pressure roller.

11. The fixing unit as claimed in claim 8, wherein the control lever comprises:
a first hinge lever having a long hole connected to the rotation axis of the pressure roller; and
a second hinge lever moving in conjunction with the first hinge lever,
wherein, when the second hinge lever rotates, the first hinge lever rotates in conjunction with the second hinge lever and shifts the rotation axis of the pressure roller, where the rotation axis is joined with the long hole.

12. The fixing unit as claimed in claim 8, wherein the bush has an asymmetric structure.

13. An image forming apparatus, comprising:
a developing unit including a photosensitive drum to develop a toner image onto a printable medium; and
a fixing unit arranged to fix the toner image onto the printable medium, the fixing unit including a heat roller to heat the printable medium on which the toner image is developed, and a pressure roller to face the heat roller and form a contact nip in an axial direction with the heat roller when the pressure roller is in contact with the heat roller,
wherein the fixing unit is further provided with a contact nip adjusting mechanism arranged at both ends of the pressure roller to adjust the contact nip by shifting the pressure roller in a paper feed direction so as to control paper skewing.

14. The image forming apparatus as claimed in claim 13, wherein the contact nip adjusting mechanism comprises:
a bush arranged at both ends of the pressure roller and to support a rotation axis of the pressure roller, and provided with a guide slit;
a guide rail arranged at both ends of the pressure roller to guide the lifting or lowering of the bush, and provided with a contact rib projected through the guide slit when the bush is lowered;
an elastic member to provide an elastic force to the bush in a direction that the pressure roller comes in contact with the heat roller; and
a control lever arranged to move the pressure roller to the opposite direction with respect to an electric force of the elastic member,
wherein, when the pressure roller is moved in an opposite direction with respect to the elastic force of the elastic member by the control lever, the bush is lowered, the contact rib is projected through the guide slit, and the projected contact rib comes in contact with the rotation axis of the pressure roller, thereby shifting the rotation axis.

15. The image forming apparatus as claimed in claim 14, wherein the control lever comprises:
a first hinge lever having a long hole connected to the rotation axis of the pressure roller; and
a second hinge lever moving in conjunction with the first hinge lever,
wherein, when the second hinge lever rotates, the first hinge lever rotates in conjunction with the second hinge lever and shifts the rotation axis of the pressure roller, where the rotation axis is joined with the long hole.

16. The image forming apparatus as claimed in claim 8, wherein the bush has an asymmetric structure.
